(19) United States
(12) Patent Application Publication
(10) Pub. No.: US 2009/0076663 A1
(43) Pub. Date: Mar. 19, 2009

(54) Method and Device for Assigning a Wheel of a Motor Vehicle

(75) Inventors: Janos Gila, Modling (AT); Alfred Pohl, Mistelbach (AT); Robert Tschofen, Wien (AT)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/233,159

(22) Filed: Sep. 18, 2008

(30) Foreign Application Priority Data
Sep. 18, 2007 (DE) 10 2007 044 396.1

(51) Int. Cl. G06F 19/00

(52) U.S. Cl. 701/1

(57) ABSTRACT

A method and device for assigning a vehicle wheel to axles having different wheel sizes. The method includes measuring the acceleration “a” sensed by an acceleration sensor of a wheel electronic system in a wheel. The measured acceleration value is transmitted to an evaluation unit, which compares the measured acceleration value “a” with a standard value stored in a memory for a standard wheel. The evaluation unit assigns the vehicle wheel to an axle as a function of the comparison result. The method and device are particularly suited to determining lift axles for trucks.

The invention relates to a method and a device for assigning a wheel of a motor vehicle.

One function of wheel pressure control systems is the automatic localization of the individual wheels. This function is used in order to automatically detect the position of a wheel and/or the wheel electronic system installed in the wheel. It is as a result possible to display the warning messages in respect of a wheel to the driver, said displays being directly coupled to the corresponding wheel position. With the localization, a distinction is made between the complete localization (position of all four wheels), the axle localization (front/rear) as well as the side localization (right/left).

One approach to axle localization includes measuring signal intensities, which are transmitted by the wheel electronic systems of different axles and are received by an antenna, which is arranged asymmetrically in respect of the axles. Alternatively, the wheel position can be determined directly by the wheel electronic system; either based on plausibility checks or by assuming that the motor vehicle mainly moves forward.

The detection of different wheel diameters may also restrict the selection of possible wheel positions. In the USA, special so-called lift axles have wheels which are smaller than the wheels of the driven axle for instance by up to 90%. With agricultural vehicles such as tractors, the wheel positions can as a result be determined at least in respect of the front and/or rear axle, provided a distinction can be made in respect of the wheel diameter. This is not possible with the afore-described intensity measurement. The intensity measurement is also disadvantageous in that a special transmit/receive device as well as an evaluation unit are needed herefor.

The object underlying the present invention is thus to enable an assignment of wheels, which is achieved with minimum technical effort.

This object is achieved in accordance with the invention by a method as claimed in claim 1 and a device as claimed in 7. Advantageous embodiments and developments, which can be used individually or in combination with one another, form the subject matter of the dependent claims.

In a first aspect of the invention, a method is proposed for assigning a vehicle wheel to axles with different wheel sizes having the following methods steps:
measuring the acceleration aᵣ experienced by an acceleration sensor of a wheel electronic system in a wheel,
transmitting the measured acceleration value aᵣ to an evaluation unit
comparing the measured acceleration value aᵣ with a standard value stored in a memory for a standard wheel by means of the evaluation unit; and
assigning the vehicle wheel to an axle by means of the evaluation unit as a function of the comparison result.

The assignment of a wheel to an axle with associated vehicle wheels takes place on the basis of the revolution speed. A wheel which has a smaller diameter rotates faster than a larger wheel at the same traveling speed. When traveling, the different variables thus result in different accelerations.

These are measured by means of acceleration sensors in the wheel electronic system, which is also known as Wheel Unit (WU). In this process, the extent of the radial acceleration aᵣ of the wheel electronic system on the periphery of the rim is measured during the journey and is transmitted to an evaluation unit. The respective acceleration values are compared in the evaluation unit with a standard value, which is stored for standard wheels. An assignment of the axles, which distinguishes normal axles from lift axles, is thus possible based on the acceleration.

In a preferred embodiment of the invention, the wheel electronic system of the wheel is assigned to an axle with a smaller wheel size if the comparison result shows that the measured acceleration value aᵣ is greater than the standard value used for comparison purposes.

In a further preferred embodiment of the invention, the wheel electronic system of the wheel is assigned to an axle with a standard wheel size, if the comparison value shows that the measured acceleration value aᵣ is less than the standard value used for comparison purposes.

In a further preferred embodiment of the invention, standard values for different standard wheels are stored in the memory.

Standard values, with which external physical basic conditions are considered, are expediently stored in the memory.

It has proven worthwhile for the physical basic conditions to include the ambient temperature, the wheel temperature, the vehicle speed and/or the tire air pressure.

In a second aspect of the invention, a device is proposed for assigning a vehicle wheel to axles with different wheel sizes having the following features:
a communication facility for receiving measured and transmitted acceleration values aᵣ, and
an evaluation unit for implementing a comparison between an acceleration value aᵣ transmitted from the communication facility to the evaluation unit and a stored standard acceleration value, with it being possible to assign the vehicle wheel to an axle by means of the evaluation unit as a function of the comparison result.

Further details and advantages of the invention are described with reference to the appended Figures, in which;

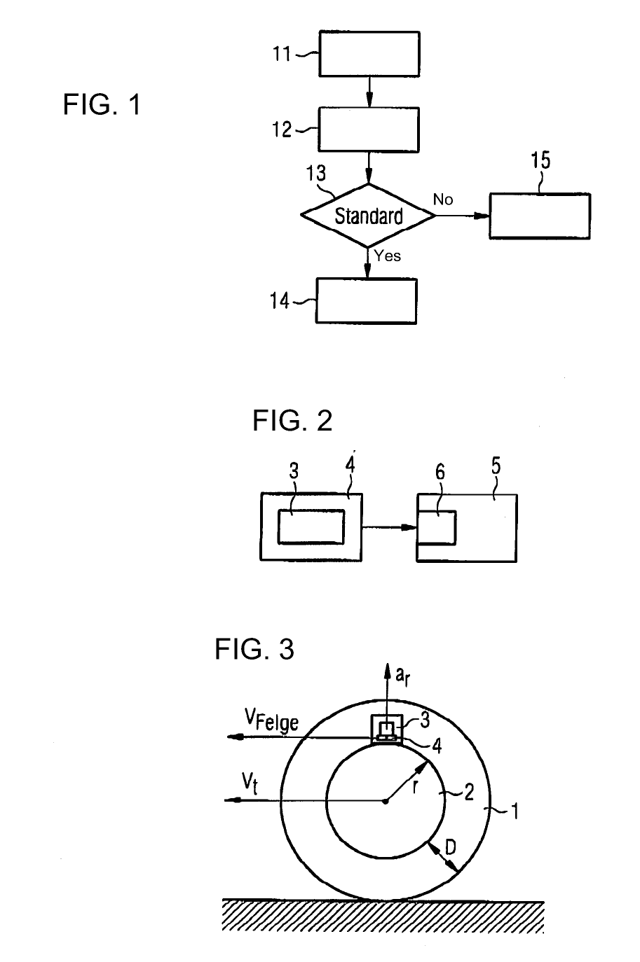

FIG. 1 shows a schematic representation of a flow chart for method steps for assigning the wheel electronic system;

FIG. 2 shows a schematic representation of a block diagram of a device for assigning the wheel electronic system; and

FIG. 3 shows a vehicle wheel with a wheel electronic system.

With the description of a preferred embodiment of the present invention below, the same reference characters refer to identical or comparable components.

The main method steps for assigning wheel electronic systems 4 are shown schematically in FIG. 1 with reference to the device according to FIG. 2. In a first method step 11, the acceleration aᵣ experienced by acceleration sensor 3 of a wheel electronic system 4 in a wheel 1 is measured. In the next method step 12, the measured acceleration value aᵣ is transmitted to an evaluation unit 5. In subsequent method step 13, a comparison of the measured acceleration sensor aᵣ with a standard value stored in a memory for a standard wheel is implemented by the evaluation unit 5. Finally, in the last method steps 14, 15, the vehicle wheel 1 is assigned to an axle by means of evaluation unit 5 as a function of the comparison result. In this process, the assignment 14, 15 is carried out for instance in the form such that with a positive comparison, identified with “yes” in the Figure, a correspondence with a standard wheel 1 is determined and with a negative comparison, identified with “no” in the Figure, a deviation from a standard wheel is determined.

FIG. 2 shows a schematic representation of the design of the device for assigning the wheel electronic system 4. An acceleration sensor 3, which is integrated in a wheel electronic system 4, measures the respective accelerations aᵣ. The acceleration signals are then sent to a communication facility 6, from which the signals are fed to an evaluation unit 5. The communication facility 6 can be integrated in the evaluation unit 5. This evaluation unit 5 is typically arranged at the vehicle end. In the evaluation unit 5, a comparison is finally made between the transmitted acceleration value a r and a previously stored standard value. An assignment of axles with different wheel sizes is thus possible based on the acceleration aᵣ. Smaller wheel sizes are used in lift axles in trucks for instance and are assigned accordingly by the present invention.

FIG. 3 shows a schematic representation of a vehicle wheel 1 with a wheel electronic system 4 and an integrated acceleration sensor 3, which is arranged on a rim 2. The rim radius r and the distance D between the outer radius of the rim 2 and the periphery of the vehicle wheel 1 is also shown. The radial acceleration aᵣ of the wheel electronic system 4 is measured on the wheel periphery.

A wheel 1 is assigned to an axle with associated vehicle wheels 1 on the basis of the revolution speed of the wheel 1. A wheel 1, which has a smaller diameter, rotates faster than a larger wheel 1 when at the same traveling speed. The different variables also result in different accelerations aᵣ while traveling. These are measured by the acceleration sensors 3 in the wheel electronic system 4, which is also known as Wheel Unit (WU). Here the extent of the radial acceleration aᵣ of the wheel electronic system 4 on the rim periphery is measured during the journey and is transmitted to the evaluation unit 5.

The vehicle speed vₜ as well as the speed v_{RIM} of the wheel electronic system is also shown on the rim. The basis of the radial acceleration aᵣ can produce the following ratio:

aᵣ=rω²=v²_{RIM}/r=r(vₜ²/(r+D)²)

The variable vₜ is in this case the vehicle speed, which is stored on a conventional CAN-BUS in the vehicle electronic systems and is measured there. The additional variables are r=rim radius, D=distance between the outer radius of the rim 2 and the wheel periphery, i.e. the outer periphery of the wheel, as well as v_{RIM}=speed of the wheel electronic system 4 on the rim 2.

Factor B which shows a characteristic for the wheel geometry can be determined herefrom.

Bvₜ²=r(vₜ²/(r+D)²) [symbol] B=r/r+D)²

whereby B is known from B=aᵣ/vₜ².

If it is assumed that the wheel height is proportionate to the rim radius between 0 and 0.5, a value of (1/2.25r) up to 1/r results for factor B.

The present invention is particularly suited to determining lift axles for trucks.

1-7. (canceled)

8. A method for assigning a vehicle wheel to axles with different wheel sizes, comprising the following steps:
measuring acceleration “a” sensed by an acceleration sensor of a wheel electronic system associated with a vehicle wheel;
transmitting the measured acceleration value “a” to an evaluation unit;
comparing the measured acceleration value “a” with a standard value stored in a memory for a standard wheel to produce a comparison result; and
assigning the vehicle wheel to an axle by the evaluation unit as a function of the comparison result.

9. The method according to claim 8, including the step of: assigning the wheel to an axle with a smaller wheel size if the comparison result indicates that the measured acceleration value “a” is greater than the standard value stored in the memory.

10. The method according to claim 8, including the step of: assigning the wheel to an axle with a standard wheel size if the comparison result indicates that the measured acceleration value “a” is less than the standard value stored in the memory.

11. The method according to claim 8, including the further step of: storing standard values for different standard wheels in the memory.

12. The method according to claim 8, including the further step of: storing standard values to be considered with respect to external physical basic conditions in the memory.

13. The method according to claim 12, wherein the physical basic conditions include one or more of ambient temperature, wheel temperature, vehicle speed, and tire air pressure.

14. A device for assigning a vehicle wheel to axles with different wheel sizes, comprising the following:
a communication facility for receiving measured and transmitted acceleration values “a”; and
an evaluation unit for comparing an acceleration value “a” transmitted from said communication facility to said evaluation unit with a stored standard acceleration value to produce a comparison result, to enable assignment of the vehicle wheel to an axle by said evaluation unit as a function of the comparison result.

15. The device according to claim 14, including a wheel electronic system associated with a vehicle wheel, said electronic system having an acceleration sensor to measure and transmit acceleration values.

16. The device according to claim 14, including a memory which stores standard values for standard vehicle wheels.
